(19) United States
(12) Patent Application Publication
(10) Pub. No.: US 2006/0046013 A1
(43) Pub. Date: Mar. 2, 2006

(54) Super-resolution information storage medium and method of and apparatus for recording/reproducing data to/from the same

(75) Inventors: Jae-cheol Bae, Suwon-si (KR); Joo-ho Kim, Yongin-si (KR); In-oh Hwang, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/127,129

(22) Filed: May 12, 2005

(30) Foreign Application Priority Data
Aug. 25, 2004 (KR) 2004-67192

(51) Int. Cl. B32B 3/02

(52) U.S. Cl. 428/64.4

(57) ABSTRACT

A super-resolution information storage medium and a method and apparatus for recording and/or reproducing data to and/or from the same, the super-resolution information storage medium designed to allow reproduction of information recording marks smaller than a resolution limit of an incident beam and includes a substrate, a recording layer formed on the substrate and having recording marks formed due to thermal decomposition at a portion on which the incident beam is focused, and a super-resolution layer formed on the recording layer using a material having a melting point lower than the thermal decomposition temperature of the recording layer. The super-resolution information storage medium has a super-resolution layer made of a material having a melting point lower than the thermal decomposition temperature of the recording layer so that the recording layer is not adversely affected due to repeated irradiation with a readout beam, thereby providing improved readout performance.

### CROSS-REFERENCE TO RELATED APPLICATION

This application claims the priority of Korean Patent Application No. 2004-67192, filed on Aug. 25, 2004 in the Korean Intellectual Property Office, the disclosure of which is incorporated herein by reference.

### BACKGROUND OF THE INVENTION

1. Field of the Invention

The present invention relates to an information storage medium having a super-resolution structure and a method of and apparatus for recording and/or reproducing data to and/or from the same, and more particularly, to a super-resolution information storage medium designed to allow reproduction of information recorded in recording marks smaller than the resolution limit of a readout beam while preventing degradation of a readout signal after repeated data reproductions and a method of and apparatus for recording and/or reproducing data to and/or from the same.

2. Description of the Related Art

An optical pickup performs non-contact recording and/or reproducing to and/or from an optical recording medium. Since the industry advancements have increased the demands for high-density recording, an optical recording medium based on a super-resolution phenomenon and having recording marks smaller than the resolution limit of a laser beam is being developed. When a wavelength of a light source is λ and a numerical aperture of an objective lens is NA, a readout resolution limit is λ/4NA. That is, it is generally impossible to read out recording marks smaller than λ/4NA since a beam emitted by a light source cannot discern them.

However, the super-resolution phenomenon allows readout of a recording mark smaller than the resolution limit, and research is currently being conducted to develop super-resolution recording media. Since a super-resolution technique enables readout of recording marks smaller than the resolution limit, super-resolution recording media using this technique can substantially satisfy the demands for high density and high capacity recording.

An example of super-resolution information media is a storage medium consisting of a metal oxide layer such as a platinum oxide (PtOₓ) layer and a phase-change layer such as a germanium-antimony-tellurium (Ge—Sb—Te) layer. Various interpretations attempt to clarify the principle of super-resolution readout. One of these interpretations asserts that PtOₓ is decomposed into Pt and O during recording and surface plasmons are generated from Pt particles during readout.

To commercialize super-resolution information storage media, basic recording and readout requirements must be met. That is, the main challenge for the super-resolution information storage media is to provide good characteristics of an RF readout signal, carrier-to-noise ratio (CNR) and jitter and to ensure stability in a readout signal. In particular, due to the use of higher power recording and readout beams that are common to information storage media, it is essential for a super-resolution information storage medium to prevent degradation of a readout signal after repeated data reproductions, thereby providing stability in the readout signal.

### SUMMARY OF THE INVENTION

According to an aspect of the present invention, there is provided a super-resolution information storage medium designed to improve stability in a readout signal by preventing degradation of the readout signal after repeated data reproductions, and a method of and apparatus for recording and/or reproducing data to and/or from the same.

According to another aspect of the present invention, there is provided a super-resolution information storage medium designed to allow reproduction of information recording marks smaller than a resolution limit of an incident beam, the medium including a substrate; a recording layer that is formed on the substrate and has recording marks formed due to thermal decomposition at a portion on which an incident beam is focused; and a super-resolution layer formed on the recording layer using a material having a melting point lower than the thermal decomposition temperature of the recording layer.

According to another aspect of the present invention, the super-resolution information storage medium may include: a substrate; a recording layer that is formed on the substrate and has recording marks formed due to thermal decomposition at a portion on which a recording beam is focused; and a super-resolution layer that is formed on the recording layer and includes a super-resolution region corresponding to a portion of a readout beam spot where melting occurs and a non-super-resolution region corresponding to the remaining portion of the readout beam spot where no melting occurs. Data recorded on the recording layer is reproduced due to a refractive index difference between the super-resolution and non-super-resolution regions.

According to another aspect of the present invention, the recording layer may be made of at least one of platinum oxide (PtOₓ), gold oxide (AuOₓ), palladium oxide (PdOₓ)), and silver oxide (AgOₓ). The super-resolution layer can be made of a material containing at least one element of indium (In), selenium (Se), tin (Sn), bismuth (Bi), lead (Pb), zinc (Zn), and tellurium (Te). The super-resolution layer includes a compound selected from the group consisting of Bi—Ga, Au—In, Al—Sn, Ga—Zn, As—Te, P—Sn, Pd—Se, Se—Sn, In—Pb, Ag—Bi, Ge—Se, As—Se, Al—Ga, Ag—Sb, Au—Bi, Au—Te, S—Se, Pb—Pd, Pb—Te, Sb—Zn, Ga—Sn, Ag—In, Al—Zn, As—Pb, Ge—In, Ga—Ge, Bi—Pd, Au—Ga, In—Sn, Pb—Pt, Se—Te, Sb—Se, Pd—Te, Si—Te, Sn—Zn, Ag—Ga, Au—Ge, Au—Pb, Ga—in, As—Bi, Ge—Sn, Al—Ge, In—Pb, S—Te, In—Te, Pb—Sb, Sb—Sn, Ag—Pb, Au—Sb, Bi—S, Ge—Te, Al—Te, In—Zn, Pb—Sn, Sb—Te, In—Sb, Ag—Sn, Ga—Te, Ge—Zn, Bi—In, Bi—Pb, Au—Si, Bi—Sb, Ag—Te, Bi—Sn, Au—Sn, Bi—Te, and Bi—Zn, or a compound containing at least one element in addition to the above compounds. The super-resolution information storage medium further includes a super-resolution layer formed between the substrate and the recording layer.

According to another aspect of the present invention, there is provided a method of reproducing data from a super-resolution information storage medium designed to allow reproduction of information recorded in recording marks smaller than a resolution limit of an incident readout beam, the super-resolution information storage medium including: a substrate; a recording layer that is formed on the substrate and has recording marks formed due to thermal decomposition at a portion on which a recording beam is focused; and a super-resolution layer formed on the recording layer. The method includes: irradiating a readout beam on the super-resolution layer so that only a portion of a readout beam spot melts in order to form a super-resolution region and a non-super resolution region surrounding the super-resolution region and reproducing data recorded on the recording layer due to a refractive index difference between the super-resolution region and the non-super-resolution region.

According to another aspect of the present invention, there is provided an apparatus for reproducing data recorded on a super-resolution information storage medium designed to allow reproduction of data recorded in marks smaller than a resolution limit of an incident beam, the super-resolution information storage medium including a recording layer and a super-resolution layer. The apparatus includes: a pickup irradiating the information storage medium with a readout beam having a temperature range lower than a temperature at which the recording layer undergoes thermal decomposition so that melting occurs at the super-resolution layer; a signal processor processing a readout signal generated due to a refractive index between a super-resolution region in the super-resolution layer where melting occurs and a non-super-resolution region where no melting occurs; and a controller controlling the pickup using a signal received from the signal processor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic cross-sectional view of a super-resolution information storage medium according to an embodiment of the present invention;

FIG. 2 shows a super-resolution region where melting occurs and a non-super-resolution region where no melting occurs, the two regions being divided according to the intensity distribution of a readout beam spot irradiating a super-resolution information storage medium;

FIG. 3 is a modified example of the super-resolution information storage medium of FIG. 1;

FIG. 4 is a schematic cross-sectional view of a super-resolution information storage medium according to another embodiment of the present invention;

FIG. 5 is a detailed example of an information storage medium according to an embodiment of the present invention;

FIG. 6 shows a conventional information storage medium to compare a readout signal thereof with that of the information storage medium of FIG. 5;

FIG. 7 illustrates a carrier-to-noise ratio (CNR) with respect to the number of repeated readouts in the information storage media shown in FIGS. 5 and 6; and

FIG. 8 is a schematic diagram of an apparatus for recording and/or reproducing data to and/or from a super-resolution information storage medium according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

The present invention provides a super-resolution information storage medium designed for reproducing information recorded in recording marks smaller than the resolution limit of a readout beam.

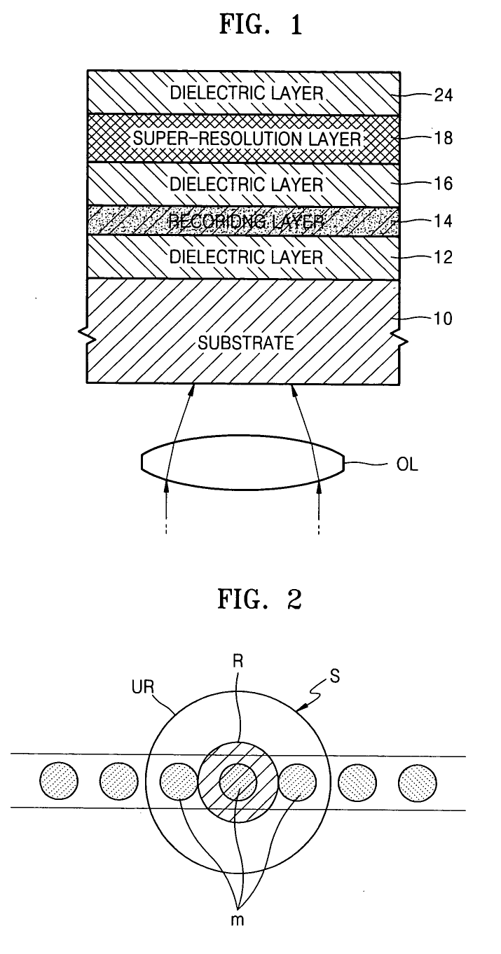

Referring to FIG. 1, a super-resolution information storage medium according to an embodiment of the present invention includes a substrate 10, and a first dielectric layer 12, a recording layer 14 irradiated with a recording beam to cause a thermal reaction, a second dielectric layer 16, a super-resolution layer 18 and a third dielectric layer 24 sequentially formed on the substrate 10.

The substrate 10 may be made of a material selected from the group consisting of polycarbonate, polymethyl methacrylate (PMMA), amorphous polyolefin (APO), and glass.

The first through third dielectric layers 12, 16, and 24 are used to control optical and/or thermal characteristics of the recording layer 14 or the super-resolution layer 18. The super-resolution information storage medium may not include the dielectric layers 12, 16, and 24. The first through third dielectric layers 12, 16, and 24 can each be made of at least one of oxide, nitride, carbide sulfide, and fluoride. That is, each of them may be made of at least one material selected from the group consisting of silicon oxide (SiO_{X}), magnesium oxide (MgO_{X}), aluminum oxide (AlO_{X}), titanium oxide (TiO_{X}), vanadium oxide (VO_{X}), chrome oxide (CrO_{X}), nickel oxide (NiO_{X}), zirconium oxide (ZrO_{X}), germanium oxide (GeO_{X}), zinc oxide (ZnO_{X}), silicon nitride (SiN_{X}), aluminum nitride (AIN_{X}), titanium nitride (TiN_{X}), zirconium nitride (ZrN_{X}), germanium nitride (GeN_{X}), silicon carbide (SiC), zinc sulfide (ZnS), a ZnS—SiO₂ compound, and magnesium difluoride (MgF₂).

The recording layer 14 may be made of metal oxide or high molecular compound. For example, the recording layer 14 can be made of at least one metal oxide selected from the group consisting of platinum oxide (PtOₓ), palladium oxide (PdOₓ)), gold oxide (AuOₓ), and silver oxide (AgOₓ). The high molecular compound may be C₃₂H₁₈N₈, H₂PC (phthalocyanine). The super-resolution layer 18 can be made of a material having a readout temperature that is lower than a recording temperature of the recording layer 14 at which thermal decomposition occurs.

Referring to FIG. 2, the super-resolution layer 18 has a super-resolution region R subjected to a change in thermal or optical characteristics according to temperature distribution created due to a difference in light intensity within a readout beam spot S focused thereon. The presence of the super-resolution region R allows readout of information recorded in recording marks m smaller than a resolution limit. The super-resolution layer 18 includes the super-resolution region R at the center or the rear of the readout beam spot S and a non-super-resolution region UR that surrounds the super-resolution region R and is not subjected to a change in thermal or optical characteristics.

More specifically, melting occurs at the super-resolution region R within the readout beam spot S while no melting occurs at the non-super-resolution region UR, thus causing a refractive index difference between both regions R and UR. Due to this refractive index difference, it is possible to reproduce recording marks smaller than the resolution limit.

Thus, a readout beam, the spot of which partially has a temperature range higher than a melting point of the super-resolution layer 18 irradiates the super-resolution layer 18 at a predetermined power. The super-resolution layer 18 may be made of a material having a melting point that is lower than the thermal decomposition temperature of the recording layer 14 so that the readout beam may not undesirably affect the recording layer 14.

For example, the super-resolution layer 18 may contain at least one element of indium (In), selenium (Se), tin (Sn), bismuth (Bi), lead (Pb), zinc(Zn), and tellurium (Te). That is, the super-resolution layer 18 may contain a compound selected from the groups consisting of Bi—Ga, Au—In, Al—Sn, Ga—Zn, As—Te, P—Sn, Pd—Se, Se—Sn, In—Pb, Ag—Bi, Ge—Se, As—Se, Al—Ga, Ag—Sb, Au—Bi, Au—Te, S—Se, Pb—Pd, Pb—Te, Sb—Zn, Ga—Sn, Ag—In, Al—Zn, As—Pb, Ge—In, Ga—Ge, Bi—Pd, Au—Ga, In—Sn, Pb—Pt, Se—Te, Sb—Se, Pd—Te, Si—Te, Sn—Zn, Ag—Ga, Au—Ge, Au—Pb, Ga—In, As—Bi, Ge—Sn, Al—Ge, In—Pb, S—Te, In—Te, Pb—Sb, Sb—Sn, Ag—Pb, Au—Sb, Bi—S, Ge—Te, Al—Te, In—Zn, Pb—Sn, Sb—Te, In—Sb, Ag—Sn, Ga—Te, Ge—Zn, Bi—In, Bi—Pb, Au—Si, Bi—Sb, Ag—Te, Bi—Sn, Au—Sn, Bi—Te, Bi—Zn, and a compound containing at least one element in addition to the above compounds.

While it is described above that the super-resolution layer 18 is located above the recording layer 14, the recording layer 14 may be, located above the super-resolution layer 18.

A readout beam that is incident through an objective lens OL disposed nearest the substrate 10 and passes upward through the substrate 10 is used to reproduce recorded data.

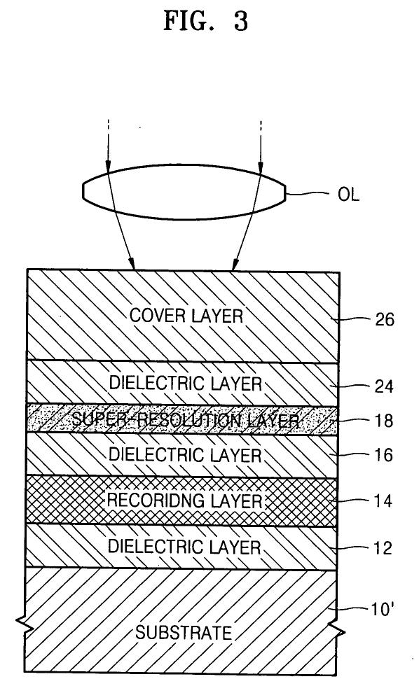

FIG. 3 is a modified example of the super-resolution information storage medium of FIG. 1. Referring to FIG. 3, a super-resolution information storage medium includes a substrate 10′, and a first dielectric layer 12, a recording layer 14 irradiated with a recording beam to cause a thermal reaction, a second dielectric layer 16, a super-resolution layer 18, a third dielectric layer 24 and a cover layer 26 sequentially formed on the substrate 10′. Since the respective layers in the information storage medium of FIG. 3 with the same reference numerals as shown in FIG. 1 perform substantially the same functions and operations as those of their counterparts, detailed descriptions thereof will not be given. The difference is that a readout beam is incident through an objective lens OL disposed nearest the cover layer 26 and passes downward through the cover layer 26.

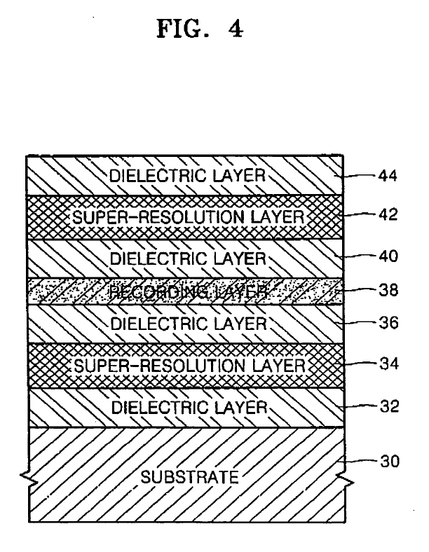

FIG. 4 is a schematic cross-sectional view of a super-resolution information storage medium according to another embodiment of the present invention. Referring to FIG. 4, the super-resolution information storage medium includes a substrate 30, a recording layer 38, and first and second super-resolution layers 34 and 42 respectively disposed above and below the recording layer 38. The dual super-resolution layers 34 and 42 can further improve readout performance. The super-resolution information storage medium further includes first through fourth dielectric layers 32, 36, 40, and 44 that are respectively disposed between the substrate 30 and the first super-resolution layer 34, between the first super-resolution layer 34 and the recording layer 38, between the recording layer 38 and the second super-resolution layer 42, and above the second super-resolution layer 42.

As described above with reference to FIG. 2, either first or second super-resolution layer 34 or 42 includes the super-resolution region R corresponding to a portion of a readout beam spot where melting occurs and the non-super-resolution region UR that surrounds the super-resolution region R and is not subjected to melting. The first and second super-resolution layers 34 and 42 may be made of a material having a melting point that is lower than the thermal decomposition temperature of the recording layer 38.

The recording layer 38 may be made of a metal oxide while the first and second super-resolution layers 34 and 42 may be made of a material that melts at a temperature lower than a temperature at which the metal oxide undergoes thermal decomposition. The material of the super-resolution layers 34 and 42 has the same properties as described earlier.

A process of recording or reproducing data on or from the super-resolution information storage medium will now be described with reference to FIGS. 1 and 2. When the recording layer 14 made of PtO_{X} in the information storage medium is irradiated with a recording beam for recording data, thermal decomposition occurs at a portion of the recording layer 14. As a result of the thermal decomposition of PtO_{X} into Pt and O, an oxygen bubble is formed and expands the portion of the recording layer 14 irradiated with the recording beam. The expanded portion becomes the recording mark m smaller than the resolution limit.

Next, when the information storage medium is irradiated with a readout beam for reproducing data, melting occurs at a portion of a spot according to temperature distribution of the readout beam spot S, thereby forming the super-resolution region R and the non-super-resolution region UR surrounding the super-resolution region R. Since no melting occurs at the non-super-resolution region UR, there is a refractive index difference between the two regions R and UR. Because of the refractive index difference, it is possible to read out marks smaller than the resolution limit.

In this case, in order to prevent degradation in a readout signal after repeated data reproductions, the super-resolution layer 18 may be made of a material having a melting point that is lower than the thermal decomposition temperature of the recording layer 14 so that the readout beam may not adversely affect the recording layer 14. For example, when the PtO_{X} recording layer is decomposed into Pt and O at about 550 to 600° C. during recording, the super-resolution layer 18 can be made of a material having a melting point lower than 550° C. If the super-resolution layer 18 is made of a phase-change material, thermal decomposition occurs at an unrecorded portion as well as recording marks on the recording layer 14 since the melting point of the phase-change material is about 600° C., thus resulting in the degradation of a readout signal after repeated data reproductions.

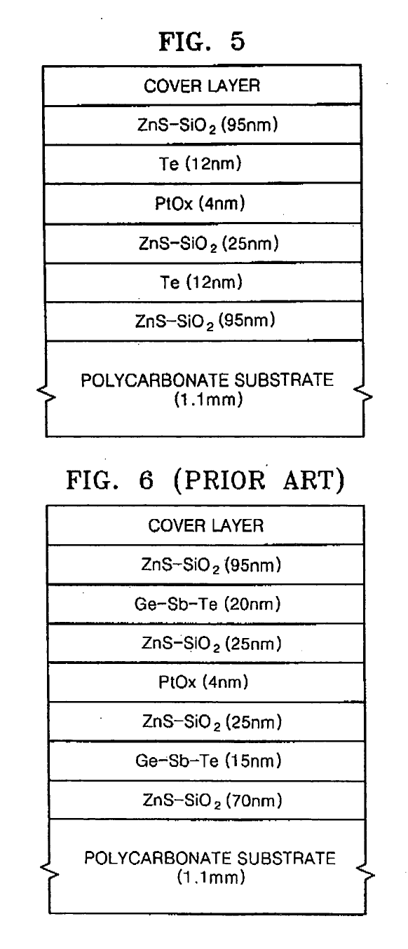

The improvement of readout signal degradation after repeated data reproductions will now be examined with reference to FIGS. 5 and 6, through a comparison between a conventional information storage medium and an information storage medium according to an embodiment of the present invention.

FIG. 5 is a detailed example of a super-resolution information storage medium according to an embodiment of the present invention. Referring to FIG. 5, the super-resolution information storage medium includes a 1.1 mm thick polycarbonate substrate, a 95 nm thick Zn S—SiO₂, a 12 nm thick Te, a 25 nm thick ZnS—SiO₂, a 4 nm thick PtO_{X}, a 12 nm thick Te, a 95 nm thick ZnS—SiO₂, and a cover layer.

On the other hand, referring to FIG. 6, a conventional information storage medium includes a 1.1 mm thick polycarbonate substrate, a 70 nm thick ZnS—SiO₂, a 15 nm thick Ge—Sb—Te, a 25 nm thick ZnS—SiO₂, a 4 nm thick PtO_{X}, a 25 nm thick ZnS—SiO₂, a 20 nm thick Ge—Sb—Te, a 95 nm thick ZnS—SiO₂, and a cover layer.

Here, a track pitch is 0.32 μm, and an optical recording and/or reproducing apparatus including a light source emitting a beam having a 405 nm wavelength and an objective lens with a 0.85 numerical aperture (NA) is used. The resolution limit is 119 nm (λ/4NA) and data is recorded in marks with a length of 75 nm smaller than the resolution limit. In the conventional information storage medium of FIG. 6, the Ge—Sb—Te layer having a melting point of about 600° C. is used as a readout layer, a threshold power is 1.5 mW, and a readout power is 1.8 mW. On the other hand, in the information storage medium of FIG. 5, the Te layer having a melting point of about 450° C. is used as a readout layer, a threshold power is 1.5 mW, and a readout power is 1.0 mW.

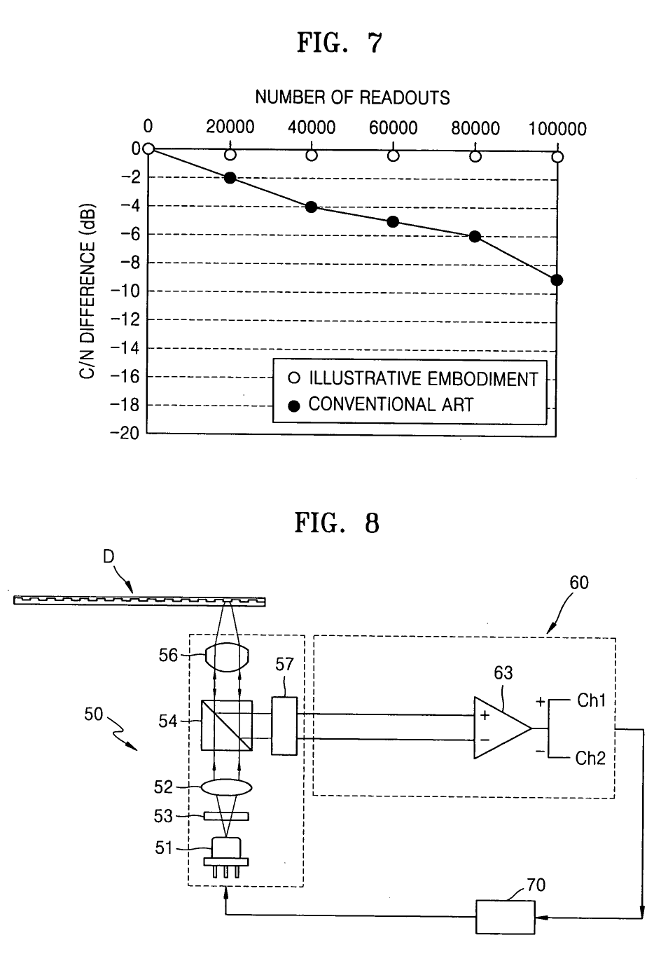

FIG. 7 is graph illustrating a carrier-to-noise ratio (CNR) with respect to the number of repeated readouts in the information storage media of FIGS. 5 and 6, respectively. Here, the ordinate and abscissa denote a value obtained by subtracting a CNR value for initial readout from a CNR value for each subsequent readout and the number of repeated readouts, respectively. As evident from FIG. 7, the CNR significantly decreases as the number of repeated readouts increases for the conventional information storage medium using the Ge—Sb—Te layer, whereas the CNR remains almost constant in the information storage medium using the Te layer according to the illustrated embodiment. That is, the super-resolution information storage medium of the illustrated embodiment of the present invention provides significantly improved readout performance over the conventional information storage medium by preventing degradation in a readout signal after repeated readouts.

When the super-resolution layer made of Ge—Sb—Te is irradiated with a readout beam having a temperature range higher than the melting point of the readout layer in order to exploit a super-resolution phenomenon, thermal decomposition also occurs at an unrecorded portion of the recording layer made of metal oxide since the melting point of the Ge—Sb—Te layer is about 600° C. and the thermal decomposition temperature of the recording layer is about 550 to 600° C. Thus, the CNR value decreases as the number of readouts increases.

However, when the Te layer is used as the super-resolution layer, there is no possibility that further thermal decomposition would occur at the recording layer made of metal oxide even when the super resolution layer is repeatedly irradiated with a readout beam since the melting point of the Te layer is 450° C. and the thermal decomposition temperature of the recording layer is about 550 to 600° C. Thus, the CNR can be kept unchanged despite increased number of readouts.

A method of reproducing data recorded on each of the information storage media of FIGS. 1, 3, and 4 having the above-mentioned structures includes irradiating the super-resolution layer 18, 34, or 42 with a readout beam so that melting occurs only at a portion of a readout beam spot in order to form the super-resolution region R and the non-super-resolution region UR surrounding the super-resolution region R and reproducing data recorded on the recording layer 14 or 38 using a refractive index difference between both of the regions R and UR. Here, the super-resolution layer 18, 34, or 42 may be melted at a temperature lower than a temperature at which the recording layer 14 or 38 undergoes thermal decomposition.

FIG. 8 is a schematic diagram of an apparatus for recording and/or reproducing data to and/or from a super-resolution information storage medium D according to an embodiment of the present invention. Referring to FIG. 8, the apparatus includes a pickup 50, a recording and/or reproducing signal processor 60, and a controller 70. Specifically, the pickup 50 includes a laser diode 51 that emits light, a collimating lens 52 that collimates the light emitted by the laser diode 51 into a parallel beam, a beam splitter 54 that changes the propagation path of the incident light, and an objective lens 56 that focuses the light passing through the beam splitter 54 onto the information storage medium D.

The information storage medium D is the super-resolution information storage medium according to an aspect of the present invention having the above-mentioned structure. The beam reflected from the information storage medium D is reflected by the beam splitter 54 and is incident on a photodetector 57 (e.g. a quadrant photodetector). The beam received by the photodetector 57 is converted into an electrical signal by an operational circuit 63 and output as an RF or sum signal through channel Ch1 and as a push-pull signal through a differential signal channel Ch2.

The controller 70 controls the pickup 50 which irradiates a recording beam on the information storage medium D and records data on the information storage medium D. The thermal decomposition temperature of the recording beam is dependent on the characteristics of a material of the recording layer (14 of FIGS. 1 and 3 and 38 of FIG. 4). The controller 70 also controls the pickup 50 to irradiate the information storage medium D with a readout beam having lower power than the recording beam so that melting occurs at the super-resolution layer (18 of FIGS. 1 and 3 and 34 and 42 of FIG. 4).

In this case, the readout beam has a temperature range lower than the thermal decomposition temperature of the recording layer. In other words, the melting point of the super-resolution layer is lower than the thermal decomposition temperature of the recording layer. Irradiation with the readout beam having this temperature range causes a super-resolution phenomenon while providing a stable readout signal even after repeated readout since there is no risk that the readout beam would undesirably affect the recording layer. The super-resolution phenomenon is as described earlier.

A beam reflected from the information storage medium D passes through the objective lens 56 and the beam splitter 54 and is incident on the photodetector 57. The beam input to the photodetector 57 is then converted into an electrical signal by the operational circuit 63 and output as an RF signal.

As described above, an information storage medium of the present invention is designed to prevent degradation in a readout signal when repeatedly reproducing information recorded in marks smaller than a resolution limit, thereby providing high-density and high-capacity recording.

The information storage medium also has a super-resolution layer made of a material having a melting point that is lower than the thermal decomposition temperature of a recording layer so that the recording layer is not adversely affected due to repeated irradiation with the readout beam, thereby providing improved readout performance.

A method of reproducing data from the super-resolution information storage medium according to an embodiment of the present invention exploits a super-resolution effect due to a refractive index difference between a super-resolution region and a non-super-resolution region, thereby allowing readout of recording marks smaller than the resolution limit.

An apparatus for recording and/or reproducing data to and/or from the super-resolution information storage medium according to an embodiment of the present invention irradiates the recording layer with a recording beam having a high thermal decomposition temperature dependent on the material of the recording layer and the super-resolution layer with a readout beam having a melting temperature lower than the thermal decomposition temperature, thereby achieving stability in a readout signal.

While it is described above that the super-resolution information storage medium has a multi-layer structure with five layers or seven layers stacked on the substrate and the super-resolution layer is made of a specific material, it will be understood by those of ordinary skill in the art that various changes in form and details may be made therein without departing from the spirit and scope of the present invention as defined by the following claims.

What is claimed is:

1. A super-resolution information storage medium designed to allow reproduction of information recording marks smaller than a resolution limit of an incident beam, the medium comprising:
a substrate;
a recording layer that is formed on the substrate and has recording marks formed due to thermal decomposition at a portion on which the incident beam is focused; and
a super-resolution layer formed on the recording layer using a material having a melting point lower than a thermal decomposition temperature of the recording layer.

2. The medium of claim 1, wherein the recording layer includes at least one metal oxide selected from the group consisting of platinum oxide (PtOₓ), gold oxide (AuOₓ), palladium oxide (PdOₓ₎), and silver oxide (AgOₓ).

3. The medium of claim 1, wherein the super-resolution layer includes at least one element selected from the group consisting of indium (In), selenium (Se), tin (Sn), bismuth (Bi), lead (Pb), zinc (Zn), and tellurium (Te).

4. The medium of claim 3, wherein the super-resolution layer comprises a compound selected from the group consisting of Bi—Ga, Au—In, Al—Sn, Ga—Zn, As—Te, P—Sn, Pd—Se, Se—Sn, In—Pb, Ag—Bi, Ge—Se, As—Se, Al—Ga, Ag—Sb, Au—Bi, Au—Te, S—Se, Pb—Pd, Pb—Te, Sb—Zn, Ga—Sn, Ag—In, Al—Zn, As—Pb, Ge—In, Ga—Ge, Bi—Pd, Au—Ga, In—Sn, Pb—Pt, Se—Te, Sb—Se, Pd—Te, Si—Te, Sn—Zn, Ag—Ga, Au—Ge, Au—Pb, Ga—In, As—Bi, Ge—Sn, Al—Ge, In—Pb, S—Te, In—Te, Pb—Sb, Sb—Sn, Ag—Pb, Au—Sb, Bi—S, Ge—Te, Al—Te, In—Zn, Pb—Sn, Sb—Te, In—Sb, Ag—Sn, Ga—Te, Ge—Zn, Bi—In, Bi—Pb, Au—Si, Bi—Sb, Ag—Te, Bi—Sn, Au—Sn, Bi—Te, Bi—Zn, and a compound containing the at least one element in addition to the above compounds.

5. The medium of claim 1, further comprising first through third dielectric layers respectively formed between the substrate and the recording layer, between the recording layer and the super-resolution layer, and above the super-resolution layer.

6. The medium of claim 5, wherein the first through the third dielectric layers includes at least one material selected from the group consisting of silicon oxide (SiO_{X}), magnesium oxide (MgO_{X}), aluminum oxide (AlO_{X}), titanium oxide (TiO_{X}), vanadium oxide (VO_{X}), chrome oxide (CrO_{X}), nickel oxide (NiO_{X}), zirconium oxide (ZrO_{X}), germanium oxide (GeO_{X}), zinc oxide (ZnO_{X}), silicon nitride (SiN_{X}), aluminum nitride (AIN_{X}), titanium nitride (TiN_{X}), zirconium nitride (ZrN_{X}), germanium nitride (GeN_{X}), silicon carbide (SiC), zinc sulfide (ZnS), a ZnS—SiO₂ compound, and magnesium difluoride (MgF₂).

7. The medium of claim 3, further comprising first through third dielectric layers respectively formed between the substrate and the recording layer, between the recording layer and the super-resolution layer, and above the super-resolution layer.

8. The medium of claim 1, wherein the melting point of the super-resolution layer is lower than 550° C.

9. The medium of claim 1, further comprising a super-resolution layer formed between the substrate and the recording layer.

10. A super-resolution information storage medium designed to allow reproduction of information recording marks smaller than a resolution limit of an incident beam, the medium comprising:
a substrate;
a recording layer that is formed on the substrate and has recording marks formed due to thermal decomposition at a portion on which a recording beam is focused; and
a super-resolution layer that is formed on the recording layer and includes a super-resolution region corresponding to a portion of a readout beam spot where melting occurs and a non-super-resolution region corresponding to a remaining portion of the readout beam spot where no melting occurs,
wherein data recorded on the recording layer is reproduced due to a refractive index difference between the super-resolution and non-super-resolution regions.

11. The medium of claim 10, wherein the recording layer includes at least one metal oxide selected from the group consisting of platinum oxide (PtOₓ), gold oxide (AuOₓ), palladium oxide (PdOₓ₎), and silver oxide (AgOₓ).

12. The medium of claim 10, wherein the super-resolution layer includes at least one element selected from the group consisting of indium (In), selenium (Se), tin (Sn), bismuth (Bi), lead (Pb), zinc (Zn), and tellurium (Te).

13. The medium of claim 12, wherein the super-resolution layer comprises a compound selected from the group consisting of Bi—Ga, Au—in, Al—Sn, Ga—Zn, As—Te, P—Sn, Pd—Se, Se—Sn, In—Pb, Ag—Bi, Ge—Se, As—Se, Al—Ga, Ag—Sb, Au—Bi, Au—Te, S—Se, Pb—Pd, Pb—Te, Sb—Zn, Ga—Sn, Ag—In, Al—Zn, As—Pb, Ge—In, Ga—Ge, Bi—Pd, Au—Ga, In—Sn, Pb—Pt, Se—Te, Sb—Se, Pd—Te, Si—Te, Sn—Zn, Ag—Ga, Au—Ge, Au—Pb, Ga—In, As—Bi, Ge—Sn, Al—Ge, In—Pb, S—Te, In—Te, Pb—Sb, Sb—Sn, Ag—Pb, Au—Sb, Bi—S, Ge—Te, Al—Te, In—Zn, Pb—Sn, Sb—Te, In—Sb, Ag—Sn, Ga—Te, Ge—Zn, Bi—In, Bi—Pb, Au—Si, Bi—Sb, Ag—Te, Bi—Sn, Au—Sn, Bi—Te, Bi—Zn, and a compound containing the at least one element in addition to the above compounds.

14. The medium of claim 10, further comprising first through third dielectric layers respectively formed between the substrate and the recording layer, between the recording layer and the super-resolution layer, and above the super-resolution layer.

15. The medium of claim 14, wherein the first through the third dielectric layers include at least one material selected from the group consisting of silicon oxide (SiO_{X}), magnesium oxide (MgO_{X}), aluminum oxide (AlO_{X}), titanium oxide (TiO_{X}), vanadium oxide (VO_{X}), chrome oxide (CrO_{X}), nickel oxide (NiO_{X}), zirconium oxide (ZrO_{X}), germanium oxide (GeO_{X}), zinc oxide (ZnO_{X}), silicon nitride (SiN_{X}), aluminum nitride (AIN_{X}), titanium nitride (TiN_{X}), zirconium nitride (ZrN_{X}), germanium nitride (GeN_{X}), silicon carbide (SiC), zinc sulfide (ZnS), a ZnS—SiO₂ compound, and magnesium difluoride (MgF₂).

16. The medium of claim 10, wherein the super-resolution layer has a melting point lower than a thermal decomposition temperature of the recording layer.

17. The medium of claim 10, wherein a melting point of the super-resolution layer is lower than 550° C.

18. The medium of claim 10, further comprising a super-resolution layer formed between the substrate and the recording layer.

19. A method of reproducing data from a super-resolution information storage medium designed to allow reproduction of information recorded in recording marks smaller than a resolution limit of an incident readout beam, the super-resolution information storage medium including a substrate, a recording layer that is formed on the substrate and has recording marks formed due to thermal decomposition at a portion on which a recording beam is focused, and a super-resolution layer formed on the recording layer, the method comprising:
irradiating the super-resolution layer with a readout beam so that only a portion of a readout beam spot melts in order to form a super-resolution region and a non-super resolution region surrounding the super-resolution region; and
reproducing the data recorded on the recording layer due to a refractive index difference between the super-resolution region and the non-super-resolution region.

20. The method of claim 19, wherein the super-resolution layer has a melting point lower than the thermal decomposition temperature of the recording layer.

21. The method of claim 19, wherein the recording layer includes at least one metal oxide selected from the group consisting of platinum oxide (PtOₓ), gold oxide (AuOₓ), palladium oxide (PdOₓ₎), and silver oxide (AgOₓ).

22. The method of claim 19, wherein the super-resolution layer includes at least one element selected from the group consisting of indium (In), selenium (Se), tin (Sn), bismuth (Bi), lead (Pb), zinc (Zn), and tellurium (Te).

23. The method of claim 22, wherein the super-resolution layer comprises a compound selected from the group consisting of Bi—Ga, Au—In, Al—Sn, Ga—Zn, As—Te, P—Sn, Pd—Se, Se—Sn, In—Pb, Ag—Bi, Ge—Se, As—Se, Al—Ga, Ag—Sb, Au—Bi, Au—Te, S—Se, Pb—Pd, Pb—Te, Sb—Zn, Ga—Sn, Ag—In, Al—Zn, As—Pb, Ge—In, Ga—Ge, Bi—Pd, Au—Ga, In—Sn, Pb—Pt, Se—Te, Sb—Se, Pd—Te, Si—Te, Sn—Zn, Ag—Ga, Au—Ge, Au—Pb, Ga—In, As—Bi, Ge—Sn, Al—Ge, In—Pb, S—Te, In—Te, Pb—Sb, Sb—Sn, Ag—Pb, Au—Sb, Bi—S, Ge—Te, Al—Te, In—Zn, Pb—Sn, Sb—Te, In—Sb, Ag—Sn, Ga—Te, Ge—Zn, Bi—In, Bi—Pb, Au—Si, Bi—Sb, Ag—Te, Bi—Sn, Au—Sn, Bi—Te, Bi—Zn, and a compound containing the at least one element in addition to the above compounds.

24. The method of claim 19, wherein the super-resolution information storage medium further comprises first through third dielectric layers respectively formed between the substrate and the recording layer, between the recording layer and the super-resolution layer, and above the super-resolution layer.

25. The method of claim 19, wherein the super-resolution layer is formed between the substrate and the recording layer.

26. An apparatus reproducing data recorded on a super-resolution information storage medium designed to allow reproduction of the data recorded in marks smaller than a resolution limit of an incident beam, the super-resolution information storage medium including a recording layer and a super-resolution layer, the apparatus comprising:
a pickup irradiating the information storage medium with a readout beam having a temperature range lower than a temperature at which the recording layer undergoes thermal decomposition so that melting occurs at the super-resolution layer;
a signal processor processing a readout signal generated due to a refractive index difference between a super-resolution region in the super-resolution layer where melting occurs and a non-super-resolution region where no melting occurs; and
a controller controlling the pickup using a signal received from the signal processor.

27. The apparatus of claim 26, where the apparatus reproduces the data recorded on the super-resolution information storage medium of claim 1.

28. The apparatus of claim 26, where the apparatus reproduces the data recorded on the super-resolution information storage medium of claim 10.

29. The method of claim 19, wherein the readout beam passes through an objective lens disposed nearest a cover layer and irradiates the super-resolution layer.

30. The method of claim 19, wherein the readout beam passes through an objective lens nearest the substrate and irradiates the super-resolution layer.

31. The method of claim 21, wherein when the recording layer including metal oxide is irradiated with the recording beam, thermal decomposition occurs at the portion of the recording layer where the recording beam is focused, resulting in the thermal decomposition of the metal oxide, forming an oxygen bubble and expanding a portion of the recording layer irradiated with the recording beam forming the recording marks.

32. The method of claim 19, wherein the readout beam has a temperature range lower than the thermal decomposition of the recording layer.

33. A super-resolution information storage medium comprising:
a substrate;
a layer formed on the substrate; and
a recording layer formed on the layer, the recording layer having recording marks formed due to thermal decomposition at a portion on which an incident beam is focused, wherein the layer has a melting point lower than the recording layer.

34. A super-resolution information storage medium comprising:
a substrate;
a first layer formed on the substrate;
a recording layer formed on the first layer, the recording layer having recording marks formed due to thermal decomposition at a portion on which an incident beam is focused; and
a second layer formed on the recording layer, wherein the melting points of the first and second layers are lower than a thermal decomposition temperature of the recording layer.

35. The storage medium of claim 34, wherein either the first or second layers include a super-resolution region corresponding to a portion of a readout beam spot where melting occurs and a non-super-resolution region corresponding to a portion of the readout beam spot where no melting occurs.
